(19) United States
(12) Patent Application Publication
(10) Pub. No.: US 2011/0306689 A1
(43) Pub. Date: Dec. 15, 2011

(54) Expandable Polystyrene and Methods of Forming the Same

(75) Inventors: Joe Shuler, League City, TX (US); Jon Tippet, League City, TX (US); John Gaustad, Friendswood, TX (US); Jose Sosa, Deer Park, TX (US)

(73) Assignee: Fina Technology, Inc., Houston, TX (US)

(21) Appl. No.: 12/796,747

(22) Filed: Jun. 9, 2010

(51) Int. Cl. C08J 9/16; C08J 9/228

(52) U.S. Cl. 521/56; 521/146

(57) ABSTRACT

Expanded polystyrene, foamed articles and methods of making the same are described herein. The expanded polystyrene generally includes polystyrene selected from expandable polystyrene and extrusion polystyrene, the polystyrene exhibiting a molecular weight of from about 130,000 Daltons to about 220,000 Daltons; a melt flow index of from about 20 to about 30 and a density of from about 0.1 lb/ft³ to about 10 lb/ft³; and wherein the expanded polystyrene exhibits a density of from about 0.1 lb/ft³ to about 10 lb/ft³.

### FIELD

Embodiments of the present invention generally relate to foamed polystyrene articles and methods of forming the same.

### BACKGROUND

Polystyrene foam is widely used for both thermal insulation and protective packaging. However, current processes and polymers experience difficulty in forming expanded polystyrene having sufficient expansion to provide desired properties to the formed articles. Therefore, a need exists to develop polystyrene capable of increased expansion while retaining beneficial properties experienced by current polymers and for use in existing processes.

### SUMMARY

Embodiments of the present invention include expanded polystyrene. The expanded polystyrene generally includes polystyrene selected from expandable polystyrene and extrusion polystyrene, the polystyrene exhibiting a molecular weight of from about 130,000 Daltons to about 220,000 Daltons; a melt flow index of from about 20 to about 30 and a density of from about 0.1 lb/ft³ to about 10 lb/ft³; and wherein the expanded polystyrene exhibits a density of from about 0.1 lb/ft³ to about 10 lb/ft³.

One or more embodiments include the expanded polystyrene of the preceding paragraph, wherein the polystyrene exhibits a melt flow index of at least 23 g/10 min.

One or more embodiments include the expanded polystyrene of any preceding paragraph, wherein the polystyrene exhibits a melt flow index of at least 25 g/10 min.

One or more embodiments include the expanded polystyrene of any preceding paragraph, wherein the polystyrene exhibits a density of from about 0.1 lb/ft³ to about 0.8 lb/ft³.

One or more embodiments include the expanded polystyrene of any preceding paragraph, wherein the polystyrene exhibits a molecular weight of from about 145,000 Daltons to about 200,000 Daltons.

One or more embodiments include the expanded polystyrene of any preceding paragraph, wherein the expanded polystyrene is formed via a single cycle expansion.

One or more embodiments include the expanded polystyrene of any preceding paragraph, wherein the expanded polystyrene exhibits a density of from about 0.1 lb/ft³ to about 1.0 lb/ft³.

One or more embodiments include a process of forming foamed polystyrene articles including providing polystyrene selected from expandable polystyrene and extrusion polystyrene, the polystyrene exhibiting a molecular weight of from about 130,000 Daltons to about 220,000 Daltons; a melt flow index of from about 20 to about 30 and a density of from about 0.1 lb/ft³ to about 10 lb/ft³; forming the polystyrene into an expanded polystyrene; and forming the expanded polystyrene into a foamed article.

One or more embodiments include the process of the preceding paragraph, wherein the polystyrene exhibits a melt flow index of at least 23 g/10 min.

One or more embodiments include the process of any preceding paragraph, wherein the polystyrene exhibits a melt flow index of at least 25 g/10 min.

One or more embodiments include the process of any preceding paragraph, wherein the polystyrene exhibits a density of from about 0.1 lb/ft³ to about 0.8 lb/ft³.

One or more embodiments include the process of any preceding paragraph, wherein the polystyrene exhibits a molecular weight of from about 145,000 Daltons to about 200,000 Daltons.

One or more embodiments include the process of any preceding paragraph, wherein the expanded polystyrene is formed via a single cycle expansion.

One or more embodiments include the process of any preceding paragraph, wherein the expanded polystyrene exhibits a density of from about 0.1 lb/ft³ to about 1.0 lb/ft³.

One or more embodiments include a foamed article formed by the process of any preceding paragraph.

One or more embodiments include the foamed article of the preceding paragraph, wherein the foamed article includes packaging material.

One or more embodiments include the foamed article of paragraph 17, wherein the foamed article includes insulation material.

### BRIEF DESCRIPTION OF DRAWINGS

FIG. 1 illustrates density versus temperature of various polymer samples.

FIG. 2 illustrates density versus MFI of various polymer samples.

FIG. 3 illustrates operating window ranges of various polymer samples.

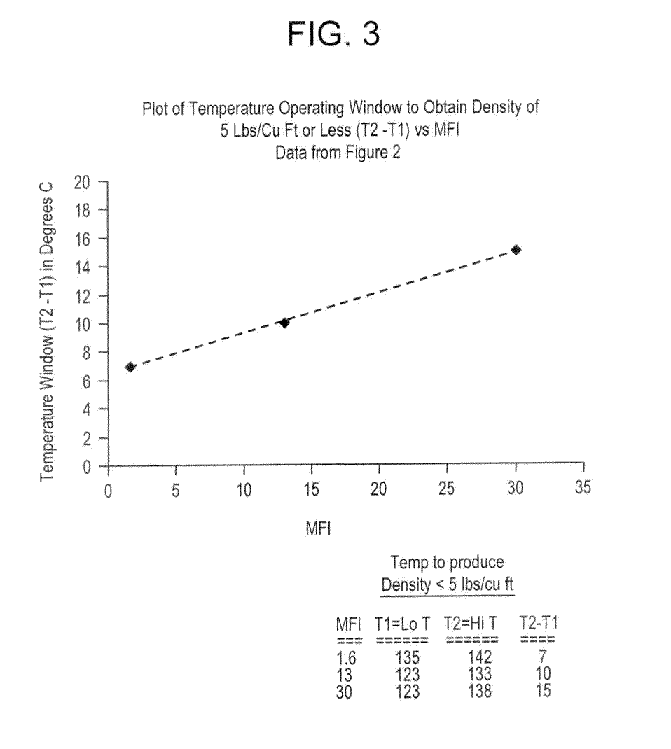

FIG. 4 illustrates a plot of bead expansion factor.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

Embodiments of the invention include foamed polystyrene articles and methods of forming the same. The foamed polystyrene articles are generally formed from expandable polystyrene or extrusion polystyrene, referred to collectively herein as EPS. The EPS may be formed by a variety of known processes. The equipment, process conditions, reactants, additives and other materials used in such polymerization processes will vary in a given process, depending on the desired composition and properties of the polymer being formed.

Expandable polystyrene may be formed in large batch processers, for example. In such processors, a large amount of raw materials (e.g., formed polystyrene, blowing agent, plasticizer) are simultaneously processed and gasified to form expandable polystyrene pellets or beads. Extrusion polystyrene may be formed using a continuous process extruder system, for example. In such extruders, a continuous supply of raw materials (e.g., formed polystyrene) is input to the extruder, heated and mixed with a blowing agent and a plasticizer. A plurality of strands of extrusion polystyrene material are then drawn from the extruder through perforations in a die and cut into pellets.

The blowing agent is generally incorporated within the formed polystyrene in a quantity sufficient such that upon heating in atmospheric steam the particle will show a 30 to 40 fold increase in volume when exposure to the heating medium (described in further detail below) is for a period of up to 10 minutes. In one or more embodiments, the blowing agents be incorporated into the formed polystyrene in an amount of from about 3 wt. % to about 10 wt. %, or from about 4 wt. % to about 8 wt. % or from about 5.5 wt. % to about 7.2 wt. %, based on the weight of formed polystyrene, for example.

Suitable blowing agents may include C₄ to C₆ aliphatic hydrocarbons, for example. In one or more embodiments, the blowing agent may be selected from pentanes (e.g., butanes, n-pentane, isopentane), hexanes, butanes, chlorodifluoromethanes, dichlorodifluoromethanes, difluoroethanes, methylchlorides and combinations thereof, for example.

The formed polystyrene may be formed by methods known to one skilled in the art, such as suspension polymerization, for example. In one or more embodiments, the formed polystyrene is a homopolymer. In other embodiments, the formed polystyrene may optionally incorporate one or more comonomers. The comonomers may include alkylstyrenes, divinylbenzene, acrylonitrile, diphenyl ether, alpha-methylstyrene or combinations thereof, for example. In one or more embodiments, the formed polystyrene includes from about 0 wt. % to about 30 wt. %, or from about 0.1 wt. % to about 15 wt. % or from about 1 wt. % to about 10 wt. % comonomer, for example.

The formed polystyrene may exhibit a melt flow index (MFI) (as measured by ASTM D 1238 condition 200° C./5 kg) of at least 20 g/10 min., or of at least about 23 g/10 min., or of at least about 25 g/10 min. or from about 20 g/10 min. to about 30 g/10 min., for example.

For a given melt flow index, molecular weight can generally be calculated according to the corresponding formulas for polystyrene with monomodal molecular weight distribution (Equation 1) and for mixtures or blends Mw can be calculated, where C₁ is the weight fraction of component 1 (Equation 2):

MFI=(10¹⁹)M_{w}^{-3.41}; Equation 1

M_{w}=C₁(M_{w})₁+(1−C₁)(M_{w})₂; Equation 2.

Accordingly, the formed polystyrene may exhibit a molecular weight M_{w} (as measured by GPC) of from about 100,000 Dalton to about 300,000 Dalton, or from about 125,000 Dalton to about 225,000 Dalton, or from about 130,000 Dalton to about 220,000 Dalton or from about 145,000 Dalton to about 200,000 Dalton, for example.

The formed polystyrene may exhibit a density of from about 0.1 lb/ft³ to about 10 lb/ft³, or from about 0.4 lb/ft³ to about 1 lb/ft³ or, from about 0.5 lb/ft³ to about 0.8 lb/ft³, for example.

The EPS may be expanded by known methods. For example, the EPS may be expanded by exposure to a heating medium, such as hot air, heated liquid or steam at about atmospheric pressure, resulting in expanded polystyrene. The heating medium may be terminated and the particles permitted to stand at ambient conditions for a period of time prior to subsequent contact with the heating medium for a secondary expansion, for example. Such processes may be repeated for any desired number of cycles.

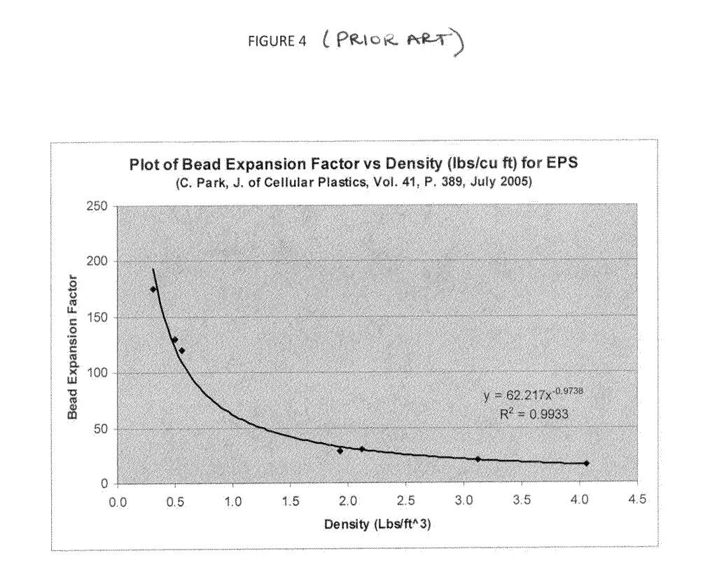

Many applications utilizing expanded polystyrene require certain properties, such as resiliency. It has been demonstrated that highly expanded foams exhibit resiliency. However, existing processes have experienced difficulties formed highly expanded foams (e.g., foams having an expansion ratio of at least 200, for example) and have required use of multiple cycles to approach such expansion ratios. As used herein, the term “expansion ratio” is measured as by the ratio of cross-sectional area of foamed strand/cross-sectional area of die and increases as density of the expanded polystyrene decreases (see, Plot of Bead Expansion Factor vs Density for EPS, C. Park, J. of Cellular Plastics, Vol. 41, P. 389, July 2005, which is included below). As illustrated below, expansion factor is generally calculated by the following formula (and illustrated in FIG. 4):

Expansion factor=62.2×(density)^{-0.9738}; Equation 3.

Accordingly, embodiments of the invention result in expanded polystyrene exhibiting a “low density”. For example, the expanded polystyrene may exhibit a density of from about 0.1 lb/ft³ to about 10 lb/ft³, or from about 0.1 lb/ft³ to about 5.0 lb/ft³ or from about 0.1 lb/ft³ to 1.0 lb/ft³, for example. The resultant foams may exhibit a cell size of from about 80 to about 250 microns, for example.

Initially, the expanded polystyrene generally can be soft and resilient, relatively flexible and provide excellent cushioning. However, over time, such properties can be reduced due to loss of blowing agent. Therefore, in order to obtain expanded polystyrene of low density, the foaming processes generally include multi-stage foaming processes (i.e., processes utilizing more than one expansion cycle).

Unfortunately, foam articles formed via multi-stage processes can experience collapse over time. However, embodiments of the invention unexpectedly result in expanded polystyrene of low density formed from single stage processes (i.e., processes utilizing a single expansion cycle).

The expanded polystyrene is useful in applications known to one skilled in the art, such as insulation and/or packaging. The insulation materials may include foam board or sheet materials, for example. Molded polystyrene foams are widely used to insulate buildings and components of buildings. Foam sheets may alternatively be thermoformed into articles, such as trays or containers or may be molded into foamed dunnage shapes suitable for packaging applications, for example.

### EXAMPLES

Foaming experiments of various polystyrenes with CO₂ were conducted on a micro-foaming apparatus. The foaming experiments were conducted in a main high pressure reactor (50 MPa bars, 453 mL) filled with a two stage sample holder. The reactor was electrically heated and had the ability for CO₂ to be pumped into the reactor in the liquid state with a high-pressure gear pump connected to the reactor through HP lines.

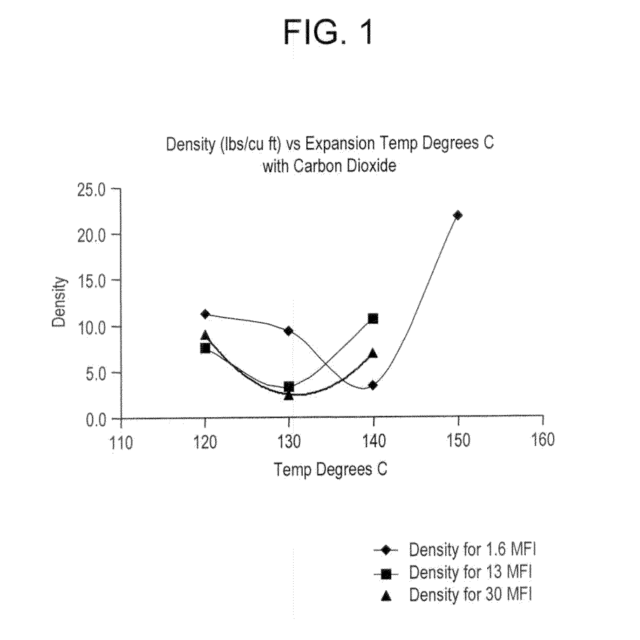

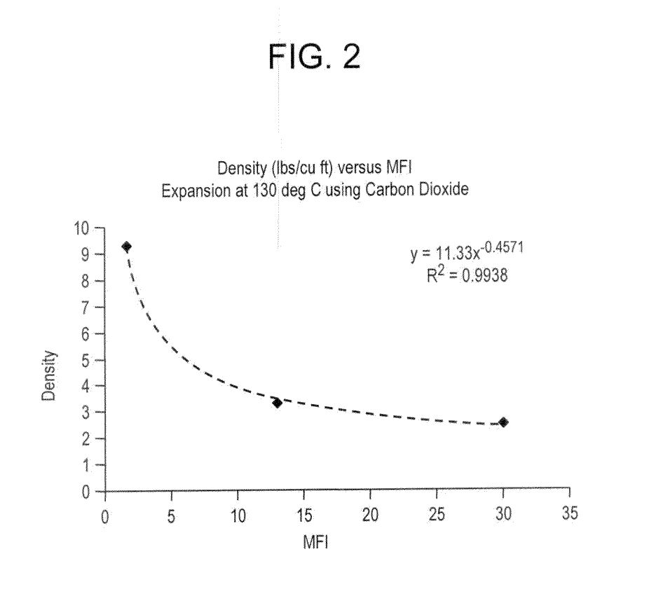

The experiments included weighing from 0.2 to 0.3 g of polystyrene in every cup placing the cups in the reactor. The reactor temperature was then raised to 200° C. for two hours under vacuum. The reactor temperature was then decreased to the required temperature (110° C. to 160° C.) and CO₂ was pumped into the reactor up to the required pressure (120 to 160 bars). The system was let under pressure and temperature overnight and then the pressure was suddenly reduced to atmospheric pressure. Air was then blown into the reactor to enhance cooling. The reactor was opened and foamed polystyrene was recovered from the cups. Density was measured by water displacement. The density results for the expanded polystyrenes (identified by MFI are illustrated in FIG. 1 for a CO₂ pressure of 150 bars and in FIG. 2 for a temperature of 130° C.

It is further noted that the parabola formed from the 30 MFI material is not as sharp as the one for 1.6 MFI (i.e., the higher MFI materials offer a broader temperature operating window than the higher molecular weight materials).

While the foregoing is directed to embodiments of the present invention, other and further embodiments of the invention may be devised without departing from the basic scope thereof and the scope thereof is determined by the claims that follow.

What is claimed is:

1. Expanded polystyrene comprising:
polystyrene selected from expandable polystyrene and extrusion polystyrene, the polystyrene exhibiting a molecular weight of from about 130,000 Daltons to about 220,000 Daltons; a melt flow index of from about 20 to about 30 and a density of from about 0.1 lb/ft³ to about 10 lb/ft³; and wherein the expanded polystyrene exhibits a density of from about 0.1 lb/ft³ to about 10 lb/ft³.

2. The expanded polystyrene of claim 1, wherein the polystyrene exhibits a melt flow index of at least 23 g/10 min.

3. The expanded polystyrene of claim 1, wherein the polystyrene exhibits a melt flow index of at least 25 g/10 min.

4. The expanded polystyrene of claim 1, wherein the polystyrene exhibits a density of from about 0.1 lb/ft³ to about 0.8 lb/ft³.

5. The expanded polystyrene of claim 1, wherein the polystyrene exhibits a molecular weight of from about 145,000 Daltons to about 200,000 Daltons.

6. The expanded polystyrene of claim 1, wherein the expanded polystyrene is formed via a single cycle expansion.

7. The expanded polystyrene of claim 1, wherein the expanded polystyrene exhibits a density of from about 0.1 lb/ft³ to about 1.0 lb/ft³.

8. A process of forming foamed polystyrene articles comprising:
providing polystyrene selected from expandable polystyrene and extrusion polystyrene, the polystyrene exhibiting a molecular weight of from about 130,000 Daltons to about 220,000 Daltons; a melt flow index of from about 20 to about 30 and a density of from about 0.1 lb/ft³ to about 10 lb/ft³;
forming the polystyrene into an expanded polystyrene; and
forming the expanded polystyrene into a foamed article.

9. A foamed article formed by the process of claim 8.

10. The foamed article of claim 9, wherein the foamed article comprises packaging material.

11. The foamed article of claim 9, wherein the foamed article comprises insulation material.

12. The process of claim 8, wherein the polystyrene exhibits a melt flow index of at least 23 g/10 min.

13. The process of claim 8, wherein the polystyrene exhibits a melt flow index of at least 25 g/10 min.

14. The process of claim 8, wherein the polystyrene exhibits a density of from about 0.1 lb/ft³ to about 0.8 lb/ft³.

15. The process of claim 8, wherein the polystyrene exhibits a molecular weight of from about 145,000 Daltons to about 200,000 Daltons.

16. The process of claim 8, wherein the expanded polystyrene is formed via a single cycle expansion.

17. The process of claim 8, wherein the expanded polystyrene exhibits a density of from about 0.1 lb/ft³ to about 1.0 lb/ft³.
